(19) United States
(12) Patent Application Publication
(10) Pub. No.: US 2022/0323295 A1
(43) Pub. Date: Oct. 13, 2022

(54) Method of Treating Urinary Dysfunction

(71) Applicants: Abraham Morgentaler, Sarasota, FL (US); Andre Danesh, Brookline, MA (US)

(72) Inventors: Abraham Morgentaler, Sarasota, FL (US); Andre Danesh, Brookline, MA (US)

(21) Appl. No.: 17/227,226

(22) Filed: Apr. 9, 2021

(51) Int. Cl. A61H 23/02

(52) U.S. Cl. CPC A61H 23/02; A61H 2205/085; A61H 2201/1207; A61H 2201/1633

(57) ABSTRACT

A process to treating urinary dysfunction in humans, male or female, comprises the steps of: (a) placing a wave front generator capable of generating a wave front to and through the perineum; (b) generating a wave front directed towards and into the pelvic floor and applying said wave front for a suitable period of time; and (c) repeating steps a and b for a suitable number of consecutive days.

### FIELD OF THE INVENTION

The invention relates generally to the field of urology. More specifically, the invention relates to a method of treating urinary dysfunction in both human males and females.

### BACKGROUND

Bothersome urinary dysfunction is common in human males and females. In one study of individuals 41 years and older, 53% of men and 61% of women reported one or more symptoms over a period of one month (Muscatello D J et al, Internal Med Journal, 2001, 31:151-160). In men, the most frequently reported symptoms were urgency and nocturia (awakening at night to urinate). In women, the most frequently cited symptoms were stress incontinence (loss of urine with cough, sneeze, or straining) and urgency. For many affected individuals, these urinary dysfunctions can impair quality of life. Treatment of these symptoms has been shown to improve quality of life (Gacci M, et al, BJUI 2003, 91:196-200).

Men and women differ in their relevant anatomy for urination primarily by the presence of a prostate in men, yet they share many other key features. In both sexes, the bladder receives the urine produced by the kidneys via the ureters, and serves as the reservoir for accumulated urine. When the bladder reaches a certain capacity, it sends a signal to the brain, and if convenient, the individual begins the process of emptying the bladder via urination. In both sexes this occurs by relaxation of the pelvic floor musculature, relaxation of the urinary sphincter and bladder neck, and contraction of the detrusor muscle that lines the bladder wall. The pelvic floor, consisting of muscles, tendons, ligaments, and connective tissue, supports the bladder in both sexes, and also the prostate in men. In men, the urine first exits the bladder by coursing through the middle of the prostate before passing through the non-prostatic portion of the urethra. In women, since no prostate is present, the urine passes directly from the bladder to the urethra.

Benign enlargement of the prostate, called benign prostatic hyperplasia (BPH) is common, affecting 48% of men over 50 years as reported in one study (Naslund M J et al, Int J of Clin Pract 2007, 61:1437-1445). As the prostate enlarges, it may cause a well-established set of symptoms, termed lower urinary tract symptoms (LUTS), that include: nocturia, slow stream, frequency, urgency, hesitancy, incomplete emptying, and urinary retention. However, not all urinary dysfunction in men in caused by the prostate. Other contributing factors include pelvic floor dysfunction, inflammation, vascular disease, stress, infection, excess fluid intake, diabetes, heart failure, neurologic conditions, as well as causes of obstruction such as stones, scar tissue, and strictures.

The primary treatment options for LUTS in men include surgery by various methods to destroy the obstructive portions of prostate tissue, medications, behavioral treatments such as reduced fluid intake, and more recently, pelvic floor physiotherapy. Surgery is associated with risks of incontinence, altered sexual function, bleeding, and with a significant rate of re-operation. The two primary classes of medications used to treat male LUTS are alpha-adrenergic blockers, and 5-alpha-reductase inhibitors. Risks of the former include syncope (loss of consciousness), reduced blood pressure, and reduced or absent ejaculatory volume with sexual activity. Risks of the latter include decreased libido, erectile dysfunction, and anorgasmia (inability to achieve orgasm). Compliance is generally poor with recommendations for reduced fluid intake and pelvic floor physiotherapy, and efficacy is limited.

In women, the primary treatments for urinary dysfunction include: medications to reduce the frequency of urination and to aid in reducing the number of events per day of stress incontinence; surgery for stress incontinence; Kegel or pelvic floor exercises to attempt to tighten the pelvic floor musculature. The most frequently used medications, called anticholinergics, are associated with dry mouth, malaise, and constipation. Surgery is performed with mesh or other materials to support the sphincter muscle, thus reducing or eliminating stress incontinence. Complications include infection, injury to the bladder or urethra, fistula (abnormal opening from bladder to vagina and/or rectum), and extrusion of sling material.

Various attempts have been made to offer treatments for urinary dysfunction. In the most relevant example pertaining to men, Henley discloses. in United States Patent Application No. 20120143107, a device and method for treating nocturia that transmits a vibratory signal into the lumbar region of a subject in order to stimulate the sacral nerve (transmitted from the designated location to a sacral nerve in the subject) to mute a bladder control signal in the sacral nerve for at least the period of time the vibratory signal is transmitted to the sacral nerve (which runs from the lower spinal cord to the bladder, and influences muscles that control the bladder) to mute a bladder control signal in the sacral nerve for at least the period of time the vibratory signal is transmitted to the sacral nerve. The disclosed method appears to specify that the vibratory signal is applied during periods of suspended consciousness, which may include meditation, sleep, sedation, anesthesia, or the like. The above named document does not disclose relief, other than in periods where there is vibratory signal applied to the sacral nerve.

In another example, Dinsmoor discloses in United States Patent Application No. 20200001090, a medical device system for treating urinary dysfunction in women, having: an implantable medical device (IMD) coupled to at least one multi-electrode lead and configured to address a plurality of stimulation vectors, wherein the IMD and at least one multi-electrode lead are configured to provide sacral neuromodulation via placement of electrodes proximate to at least one location selected from the groups consisting of: an S3 foramen and a ventral aspect of the S3 foramen. The medical device system also includes processing circuitry configured to provide pulse amplitudes and pulse widths consistent with a therapeutic regimen for treating urinary dysfunction. However, the disclosed techniques of electrode placement and implantation of neuromodulation devices are invasive and require the urologist to undergo specific training on the implantation material, the implantation technique, and parameterization of the pulse signals. Moreover, sacral neuromodulation is usually not recommended in management of urinary incontinence caused by vesical hyperactivity if rehabilitation or anticholinergic treatment has not been attempted first, unless some contraindication prevents use of anticholinergic treatments.

There is thus a clear need for a treatment for urinary dysfunction in men and women that is safe, effective, non-invasive, convenient, and does not require involvement of trained medical personnel.

### BRIEF DESCRIPTION OF THE DRAWINGS

FIG. 1 illustrates a cross section of the male urogenital system the transducer component of a wave front generator placed in proximity to the pelvic floor.

FIG. 2 illustrates a cross section of the female urogenital system with the transducer component of a wave front generator placed in proximity to the pelvic floor.

FIG. 3 illustrates an embodiment of a wave front generator comprising a chair with a built in transducer and a controller connected to the transducer.

### DETAILED DESCRIPTION

As used, the term “perineum” defines the space between the anus and the base of the scrotum in the male, and between the anus and the inferior edge of the vagina in the female. The “urogenital triangle” is approximately an isosceles triangle, comprising, in men, the space between the anus and the base of the scrotum, wherein the apex of the triangle is at the base of the scrotum and the base of the triangle is at the edge of the anal opening. The anatomy is similar in females, replacing base of scrotum with the inferior edge of the vagina. The term “urinary dysfunction” is defined to mean collectively symptomatology in either a male of a female that is bothersome to the individual, whether this be nocturia, frequency, urgency, stress incontinence, or another urinary symptom.

The process of the subject invention is a method for treating urinary dysfunction comprising the steps of: (a) placing the transducer component of a wave front generator in contact with the perineum; (b) continuously generating a wave front directed towards and into the pelvic floor for a suitable period of time; and (c) repeating steps a and b for a suitable number of consecutive days.

Wave front generators are well known in the art and preferred wave front generators for practice of the invention are mechanical. They typically comprise a controller and a transducer. The controller and the transducer may be a single device or may be separated from each other. The controller is the device that generates the wave front transmitted to the transducer. Wave front generators typically have controls that enable generation of a wave front within a wide range of frequencies ranging from extremely low frequency (ELF—the ITU designation) with frequencies from 3 to 30 Hz, up to high frequencies in excess of 10,000 MHz. The wave front generator used in the process of the subject invention in one that would operate at the lower frequencies. The preferred wave front generator is one that generates vibrations as will be discussed in greater detail below.

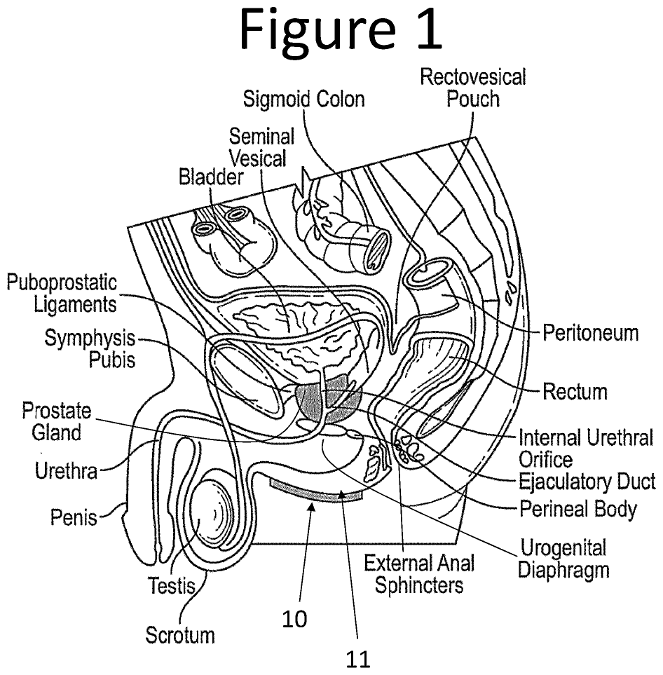

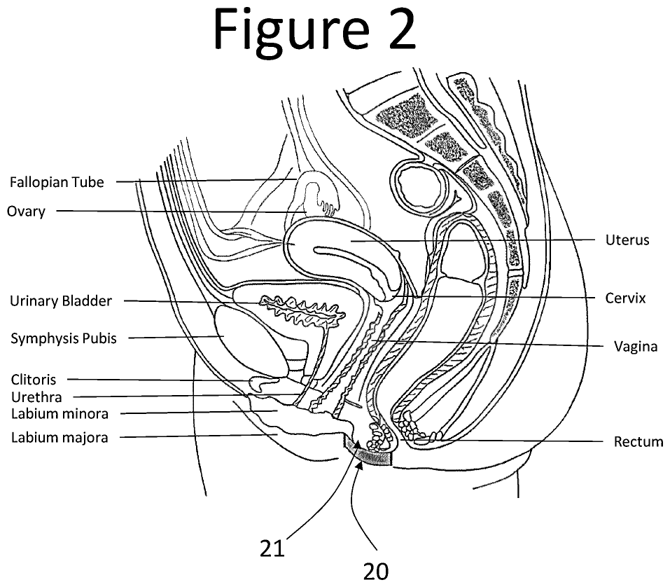

The placement of the wave front generator relative to the perineum is illustrated in FIGS. 1 and 2 of the drawings. In FIG. 1, illustrating the use of the process of the invention for treatment of urinary dysfunction in a male, a transducer 10 is located in proximity to perineum 11. Similarly, FIG. 2 illustrates the process of the invention for treatment of urinary dysfunction in a female, where transducer 20 is located in proximity to perineum 21.

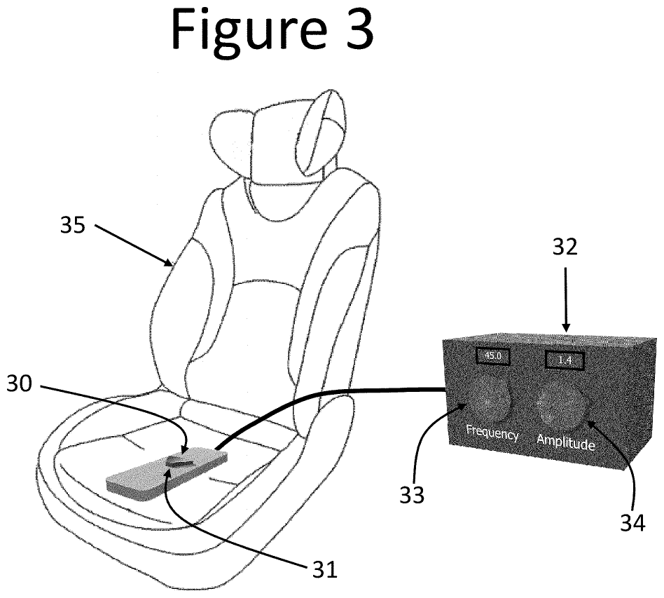

FIG. 3 illustrates one embodiment of a suitable wave front generator for use in the process of the invention. In the embodiment shown, apparatus 30 comprises a truncated vertex vibrator 31, configured on chair 35, for placement in proximity of the pelvic floor of a user, with wave front generator 30, coupled to controller 32, having control 33 to adjust frequency, and control 34 to adjust wave amplitude.

The use of a wave front to treat urinary dysfunction in accordance with the invention employs various parameters such as duration of time during which the wave front is passed through the perineum per use, the number of times the process is practiced daily or within a given period of time, wave frequency, and to a lesser extent, wave characteristics such as wave amplitude and shape. Preferred ranges for the more significant parameters are given below.

In practice of the process of the invention, wave front frequency may be as low as 5 hertz to achieve some relief of urinary dysfunction or in excess of 200 hertz. A preferred range is from 10 to 200 hertz, a more preferred range is from 20 to 100 hertz, and a most preferred range is from 20 and 60 hertz. The duration of time during which the wave front is generated and passed through the pelvic floor per use may vary between 3 and 30 consecutive minutes, but more preferably varies between 8 and 20 consecutive minutes. The number of consecutive days of use of the wave generator may be as few as 3 for at least partial relief, or may be used daily over an extended period of time without limit. Preferably, for satisfactory results, the number of days varies between 4 and 30 days, and more preferably, between 10 and 20 days. The wave front generator may be used more often than once daily. Desirably, the process is performed within 4 hours of the user retiring for the night. Of lesser importance, wave amplitude may vary between 0.005 and 10 mm though, at the present time, this is not considered to be a critical parameter.

The parameters given above are, to some extent, interrelated. For example, if the wave front generator is used, less than twice daily, it may take a longer time to achieve beneficial results. It should also be understood that the severity of symptoms vary widely between individuals, so that one individual with severe symptoms may require longer treatment regimens than someone with milder symptoms. Also, the degree of “bother,” can vary between individuals with the same degree of symptoms, such that one individual who awakens twice per night to urinate may feel this is a satisfactory result, whereas another may find this same degree of nocturia, for example, to be distressing.

In addition, using the process of the invention, relief of urinary dysfunction symptomatology takes place gradually over an extended period of time. For some individuals, improvement may begin within a few days. For others, it may take a longer period of time. Likewise, satisfactory relief of urinary dysfunction may occur with fewer continuous days of use for some individuals and for others, more days of continuous use may be required to achieve similar results.

It should also be understood that the ranges for treatment parameters given are generalized for an average individual, but different individuals may require differing use parameters. For example, tissues encountered by the wave front each have different elasticity, compressibility, viscosity, and density, such that they exhibit different acoustical impedances. In practice of the invention, for some individuals, it might be desirable to engage in routine experimentation to find the most efficacious combination of parameters for best results.

To quantify relief of urinary dysfunction, reference is made to The International Prostate Symptom Score (IPSS). This scoring protocol involves providing an individual with a patient questionnaire that includes a Quality of Life Scale at the end of the questionnaire. Symptom scores are based upon the number of times a patient answers “yes” to any of the questions within the questionnaire. The questionnaire ranks symptoms by categories, mild, moderate and severe. A range of from 0 to 7 represents mild symptoms, 8 to 19 represents moderate symptoms, and 20 to 35 represents severe symptoms. In accordance with this invention, improvement of urinary dysfunction symptoms is defined as an individual practicing the process of the invention moving from one category in the IPSS down to a lower category, for example, moving from severe to moderate, moderate to mild, or severe to mild.

In the preferred embodiment of the invention, a mechanical wave front generator is used that is a vibrator. Vibrators are commercially available. They may comprise a controller and a separate transducer or may be a single hand held instrument with the transducer mounted directly on the controller. As is known in the art, vibrators may generate vibrations using motor driven reciprocating pistons or other objects, eccentric weights driven by a conventional electric motor, or employ magneto-mechanical forces comprising electromagnet coils actuated by an alternating current signal, and further comprising magnetic metals. The vibrator may run on batteries or plug into a conventional wall socket. Further, the vibrator may use the flow of air or other gaseous or liquid fluid from a pump, either employing vacuum or positive pressure to generate the mechanical wave. Further, the vibrator may be a piezoelectric device, an electrostrictive device or an electroacoustic transducer, comprising a magnet, a function coil, a diaphragm, optionally, a suspension, and, optionally, a cooler.

The wave front generator may be placed on into, the seat of a comfortable chair as shown in FIG. 3 of the drawings or embedded in a comfortable cushion. The transducer portion of the mechanical wave generator may be positioned such that the pelvic floor makes comfortable contact, either directly or through clothing. Moreover, the transducer may have a variety of shapes and sizes to address the specific target location and fit comfortably into the desired anatomical space. These include triangular shapes, quadrilateral shapes, trapezoidal shapes, parallelogram shapes, rectangular, square shapes, round shapes, ovular, or elliptical shapes. The transducer may be generally flat, generally concave, or generally convex at the locus of contact to provide the necessary comfort and therapeutic efficacy. The transducer may further include a controller providing controls for amplitude, and frequency, as well as for waveform and the like. In addition, the wave energy generator may have additional controls such as for heating and cooling.

Directing energy via a wave front may further include applying a triangular transducer having an area of contact along at least a portion of the length of the perineum, wherein the base of the triangle is adjacent to the anus, and wherein the width of the base of the triangle is between about 0.5 cm and about 6 cm. Since individuals have perinea of different size, it is contemplated that the wave front generator would be provided with several transducers of differing sizes to accommodate individual differences.

In the following examples, The International Prostate Symptom Score (IPSS) was used to evaluate results.

### EXAMPLES

Example 1: A 71 year old male subject applied a Wahl Deep Tissue vibrator as a wave front generator to deliver a frequency of 55 Hertz to the surface of his perineum. It was initially used for 5 minutes, and then after 9 days, for 7 minutes within 4 hours prior to bed time. His response as measured by the International Prostate Symptom Score (IPSS). At baseline, prior to treatment, his symptom score was 12 out of possible score of 35 (high numbers indicate greater severity of symptoms). After two days of treatment his IPSS score had dropped to 5 and by the next day it was 2. By day 10 the IPSS was 1. This amounts to an improvement of 11 points. For context, studies show mean improvement in IPSS with standard medical therapy using alpha blocker medications such as tamsulosin or uroxatral is 5-6 points, and a decrease of 3 points in an individual is considered clinically meaningful.

Example 2: An additional example is an 87 year man with longstanding symptoms of bothersome waking at night to urinate (nocturia), three or four times each night. He applied this same apparatus to the perineum twice daily, in the morning and before bedtime, for five to seven minutes at a time. Within several days he noted reduced nocturia, and after a week he awakened to urinate only once. He continues with greatly reduced nocturia, 1-2 times per night, after 3 months of using the device, which he eventually used once daily, just before bedtime. His sleep is improved, and he feels more refreshed during the day.

Although the present invention has been shown and described with reference to particular examples, various changes and modifications which are obvious to persons skilled in the art to which the invention pertains are deemed to lie within the spirit, scope and contemplation of the subject matter set forth in the appended claims.

What is claimed is:

1. A method for treating urinary dysfunction in an individual, said method comprising the steps of:
a. placing a mechanical wave front generator in proximity to the perineum, said wave front generator being capable of generating a wave front to and through said perineum;
b. generating a wave front directed towards and into the pelvic floor and continuing the generation of said wave front for a minimum of 3 minutes; and
c. repeating steps a and b one or more times daily for a minimum of 3 consecutive days.

2. The method of claim 1, where the wave front generator is a vibrator that generates a vibratory wave front.

3, The method of claim 2 where the wave front is applied continuously for a period of time varying between 3 and 30 minutes.

4. The method of claim 2 where the wave front is applied continuously for a period of time varying between 8 and 20 minutes.

5. The method of claim 2 where the process is repeated daily for from 4 to 30 consecutive days.

6. The method of claim 5 where the process is repeated daily for from 10 to 20 consecutive days.

7. The method of claim 2 where the process is performed within 4 hours of the individual retiring for the night.

8. The method of claim 2 where the wave front frequency is at least 10 hertz.

9. The method of claim 2 where the wave front frequency varies between 10 and 200 hertz.

10. The method of claim 2 where the wave front frequency varies between 20 and 100 hertz.

11. A method for treating urinary dysfunction in an individual, said method comprising the steps of:
a. placing a mechanical wave generator in proximity to the perineum, said wave front generator being capable of generating a vibratory wave front to and through said perineum;
b. generating a wave front directed towards and into the pelvic floor and continuing the generation of said wave front for a minimum of 3 minutes; and
c. repeating steps a and b one or more times daily for a minimum of 3 consecutive days;
said steps being employing conditions sufficient to reduce The International Prostate Symptom Score down by at least one level.

12. A method for treating urinary dysfunction in a human male, said method comprising the steps of:
a. placing a mechanical wave generator in proximity to the perineum, said wave front generator being capable of generating a wave front to and through said perineum;
b. generating a wave front directed towards and into the pelvic floor and continuing the generation of said wave front for a minimum of 3 minutes; and
c. repeating steps a and b one or more times daily for a minimum of 3 consecutive days.

13. The method of claim 12, where the wave front generator is a vibrator that generates a vibratory wave front.

14, The method of claim 13 where the wave front is applied continuously for a period of time varying between 3 and 30 minutes.

15. The method of claim 13 where the wave front is applied continuously for a period of time varying between 8 and 20 minutes.

16. The method of claim 13 where the process is repeated daily for from 4 to 30 consecutive days.

17. The method of claim 13 where the process is repeated daily for from 10 to 20 consecutive days.

18. The method of claim 13 where the process is performed within 4 hours of the individual retiring for the night.

19. The method of claim 13 where the wave front frequency is at least 10 hertz.

20. The method of claim 13 where the wave front frequency varies between 10 and 200 hertz.

21. The method of claim 13 where the wave front frequency varies between 20 and 100 hertz.

22. A method for treating urinary dysfunction in a human female, said method comprising the steps of:
a. placing a mechanical wave front generator in contact with the perineum, said wave front generator being capable of generating a wave front to and through said perineum;
b. generating a wave front directed towards and into the pelvic floor and continuing the generation of said wave front for a minimum of 3 minutes; and
c. repeating steps a and b one or more times daily for a minimum of 3 consecutive days.

23. The method of claim 22, where the wave front generator generates a vibratory wave front.

24, The method of claim 23 where the wave front is applied continuously for a period of time varying between 3 and 30 minutes.

25. The method of claim 23 where the wave front is applied continuously for a period of time varying between 8 and 20 minutes.

26. The method of claim 23 where the process is repeated daily for from 4 to 30 consecutive days.

27. The method of claim 23 where the process is repeated daily for from 10 to 20 consecutive days.

28. The method of claim 23 where the process is performed within 4 hours of the individual retiring for the night.

29. The method of claim 23 where the wave front frequency is at least 10 hertz.

30. The method of claim 23 where the wave front frequency varies between 10 and 200 hertz.

31. The method of claim 23 where the wave front frequency varies between 20 and 100 hertz.

32. A method for treating urinary dysfunction in a human male, said method comprising the steps of:
a. placing a mechanical wave generator in contact with the perineum, said wave front generator being capable of generating a vibratory wave front to and through said perineum;
b. generating a wave front directed towards and into the pelvic floor and towards the prostate and continuing the generation of said wave front continuously for a period of time varying between 3 and 20 minutes; and
c. repeating steps a and b one or more times daily for a minimum of from 4 to 20 consecutive days.

33. The method of claim 32 said steps employ conditions sufficient to reduce The International Prostate Symptom Score down by at least one level.

34. A method for treating urinary dysfunction in a human female, said method comprising the steps of:
a. placing a mechanical wave generator in contact with the perineum, said wave front generator being capable of generating a vibratory wave front to and through said perineum;
b. generating a wave front directed towards and into the pelvic floor and continuing the generation of said wave front continuously for a period of time varying between 3 and 20 minutes; and
c. repeating steps a and b one or more times daily for a minimum of from 4 to 20 consecutive days.

35. The method of claim 34 said steps employ conditions sufficient to reduce The International Prostate Symptom Score down by at least one level.
